(19) United States
(12) Patent Application Publication
(10) Pub. No.: US 2016/0227115 A1
(43) Pub. Date: Aug. 4, 2016

(54) SYSTEM FOR DIGITAL MEDIA CAPTURE

(71) Applicant: Footspot, Inc., Los Angeles, CA (US)

(72) Inventors: Nathan Bin Mahfooz, Los Angeles, CA (US); Ryane Bin Mahfooz, Los Angeles, CA (US)

(73) Assignee: Footspot, Inc., Los Angeles, CA (US)

(21) Appl. No.: 15/094,203

(22) Filed: Apr. 8, 2016

Related U.S. Application Data
(63) Continuation of application No. 14/511,122, filed on Oct. 9, 2014.

(51) Int. Cl. H04N 5/232; G06F 3/16; G06F 3/0481; G06F 3/0484; H04N 5/225; H04N 5/77

(52) U.S. Cl. CPC H04N 5/23245; H04N 5/2252; H04N 5/77; H04N 5/23293; H04N 5/23216; G06F 3/04817; G06F 3/04845; G06F 3/16; G06Q 50/01

(57) ABSTRACT

A system and method is provided for media capture. The media content can be recorded via a mobile application running on a mobile device. The application presents an intuitive display in a single screen for capturing various media formats, including images, video, and audio, as well as media compilations of multiple media formats (e.g., still image and audio, video and still image, and others) in a single file.

### CROSS REFERENCE TO RELATED APPLICATION

This application is a continuation of U.S. patent application Ser. No. 14/511,122, filed on Oct. 9, 2014, which is hereby incorporated by reference.

### FIELD OF THE INVENTION

The present invention relates generally to social networking and, more particularly, to digital media capture and related social networking.

### BACKGROUND OF THE INVENTION

Many current social networking systems provide predominantly text based interactions, allowing users to communicate with others, comment on recent events, and otherwise interact with others.

Typically, social networking sites allow users to post public messages on a section of a dedicated profile page for another user; reply to or like posts; and otherwise communicate in a publicly observable group-interactive dialogue. On such sites, status updates and messages are communicated through written means, and as such, tend to be limited by the user's ability or motivation to type. While these sites frequently allow hyperlinks to other content, such as videos hosted on third-party media websites, viewing videos sometimes require users to leave the social networking site. Additionally, there is a lack of direct interaction between the video sites and the social networking sites, such that any links from the social networking site to the video site are unidirectional.

On current social networking sites, users are generally not encouraged to use video or voice to comment. When users do post a video, it is not typically their own recorded video, but rather a music video, news clip, and so on. With text-based sites tend to encourage posting of multimedia content by posting links thereto. Some such site may further enable users to post previously captured multimedia content. However, current approaches for posting presently captured multimedia can be cumbersome.

There are networking sites that focus on sharing one form or another of multimedia content, such as solely photo or solely video. However, such sites often lack in other aspects of social interaction functionality. Moreover, the means for real-time capture and posting of such content is often limited to one form of multimedia or the means for switching between types of multimedia capture can be difficult.

It should, therefore, be appreciated that there remains a need for a system and method for digital media capture and social networking that encourages communication via digital media posts in an interactive manner.

### SUMMARY OF THE INVENTION

Briefly, and in general terms, the present invention provides a system and method for media capture and social networking that encourages communication via media posts in an interactive manner. The media content can be recorded via a mobile application running on a mobile device. The application presents an intuitive display in a single screen for capturing various media formats, including images, video, and audio, as well as media compilations of multiple media formats (e.g., still image and audio, video and still image, and others) in a single file. The resulting media content can be shared to the social network via the application.

More specifically, in an exemplary embodiment, the system provides a user interface that displays, on a single screen, a plurality of functional icons selectable for capturing various media formats, including an “audio” icon, “record video” icon, and a “photo” icon.

In a detailed aspect of an exemplary embodiment, a still image is captured upon haptic contact with the photo icon. If contact continues with the display screen, then the system records audio for the duration of the haptic contact. As long as the user continues to hold his finger on the screen after pressing the photo icon, the user can drag his finger to anywhere on the device's screen and keep recording the audio content. In this manner, the user creates a media compilation of a still image and audio that, when played, displays the captured still image and plays the audio recording. The still image is displayed for the duration of the audio clip.

In another detailed aspect of an exemplary embodiment, when the user presses and holds the “record video” icon, the functional icons on the home screen 20 fade away while capturing the video. As long as the user continues to hold his finger on the screen after pressing the record video icon, the user can drag his finger to anywhere on the device's screen and keep recording. This allows the user to move his finger out of the central portion of screen as it displays the video being recorded. Upon releasing contact with the screen, the recording ends.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a screenshot of an exemplary graphical user interface (GUI) for an electronic device employing an application for a system and method for media capture and social networking in accordance with the present invention, depicting a screen for initiating capture of various media formats, including images, video, and audio, as well as media compilations of multiple media formats (e.g., still image and audio, video and still image, and others).

FIGS. 2A-B are screenshots of a GUI for editing media captured via the mobile application of FIG. 1.

FIG. 3 is a simplified flow chart showing steps for capturing media via the mobile application of FIG. 1.

FIG. 4 is a simplified flow chart showing steps for capturing a compilation of multiple media formats (e.g., still image and audio, video and still image, and others) via the mobile application of FIG. 1.

FIG. 5 is a simplified block diagram of components of a mobile device usable via the mobile application of FIG. 1.

FIGS. 6A-B are screenshots of a GUI for accessing the social networking features of the mobile application of FIG. 1, depicting a user's account details and settings.

FIG. 7A-B is a screenshot of a GUI for when viewing the user's profile of the social networking features of the mobile application of FIG. 1.

FIG. 7C is a screenshot of a GUI for when viewing a post from a user of the social networking features of the mobile application of FIG. 1.

FIGS. 8A-B are screen shots of the newsfeed and commenting functions of the social networking features of the mobile application of FIG. 1.

FIGS. 9A-D are screen shots of a GUI for location and event sharing functionality of the social networking features in accordance with the invention.

FIG. 10 is a screenshot a GUI for the footsteps screen as shown on the user interface of the social networking features in accordance with the invention.

### DETAILED DESCRIPTION OF THE PREFERRED EMBODIMENTS

Referring the drawings, there is shown a system and method for media capture and social networking that encourages communication via media posts in an interactive manner. The media content can be recorded via an application running on a mobile device. The application presents an intuitive display in a single screen for capturing various media formats, including images, video, and audio, as well as media compilations of multiple media formats (e.g., still image and audio, video and still image, and others) Moreover, compilations and permutations of captured media can be stored as a single file, wherein each media component segment can be edited individually before creating the single file. The resulting media content can be shared to the social network via the application.

### Media Capture:

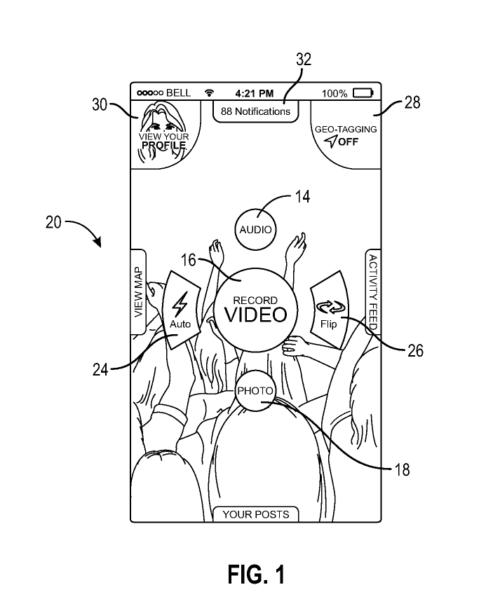

With reference to FIG. 1, there is shown a screenshot of the home screen 20 from the application running on the mobile device 10, depicting a plurality of functional icons with a background display as it appears on the display screen 12, including an “audio” icon 14, “record video” icon 16, and a “photo” icon 18. The icons are located in the foreground, while the background of the home screen 20 displays what the camera is currently viewing. The user can capture a video and/or picture and/or picture with audio, individually, or in any permutation, variation, order, combination, or arrangement desired.

In the exemplary embodiment, the mobile device 10 includes a display screen that enables the user to provide input via haptic contact with the screen, as is known in the art. For example, the touch screen of the mobile device can sense touch location, duration, and movement across the screen, from single or multiple touch contacts.

When the user presses and holds the “record video” icon 16, the video touch controller is engaged, and will capture digital media footage for the duration of the time between icon contact engagement and the icon contact release. While holding the record video icon 16, the functional icons on the home screen 20 fade away while capturing the video. As long as the user continues to hold his finger on the device's screen 12 after pressing the record video icon 16, the user can drag his finger to anywhere on the device's screen 12 and keep recording. This allows the user to move his finger out of the central portion of screen as it displays the video being recorded. Upon releasing contact with the screen, the recording ends.

When the user presses the photo icon 18 on the display screen 12, the photograph touch controller is engaged, and a still image is captured upon haptic contact. If contact continues with the photo icon 18, then the audio touch controller engages simultaneously with, or shortly thereafter, the capture of the image, and the system 22 records audio for the duration of the haptic contact, then pairs the recorded audio with the still image captured when the user first pressed the photo icon 18. As long as the user continues to hold his finger on the screen after pressing the photo icon 18, the user can drag his finger to anywhere on the device's screen and keep recording the audio content. In this manner, the user creates a media compilation of a still image and audio that, when played, displays the captured still image and plays the audio recording. The still image is displayed for the duration of the audio clip.

When the user presses and holds the “audio” icon 14, the audio touch controller is engaged and the system records audio until the user releases contact. While continuing to hold the audio icon 14, the functional icons on the home screen fade away while capturing the audio. As long as the user continues to hold his finger on the screen after pressing the record audio icon 14, the user can drag his finger to anywhere on the device's screen and keep recording. Upon releasing contact with the screen, the audio recording ends.

With continued reference to FIG. 1, all of the media capture icons, as well as other functional icons, are accessible on the main screen, requiring no additional navigation to access each icon. The “record video” icon 16 is centrally located in the screen. The record video icon 16 having a circular shape. The “audio” icon 14 is located above the “record video” icon 16. The “audio” icon 14 has a circular shape having a smaller radius than the record video icon 16. A “photo” icon 18 is located below the “record video” icon 16. The “photo” icon has a circular shape of the same radius as the audio icon 14. A “flash” icon 24 is located to the left of the record video icon 16. The flash icon 24 has an arc shape, aligned with the record video icon 16. A “flip camera” icon 26 is located to the right of the record video icon 16. The flip icon's 26 shape is a mirror image of the “flash” icon's 24 shape. Located in the upper right corner of the home screen is a “Geo-Tagging” icon 28. A “view your profile icon” 30 is located in the upper left corner. The top center of the home screen has a status bar 32 for notifications. Swiping from top to bottom gives access to the notifications center.

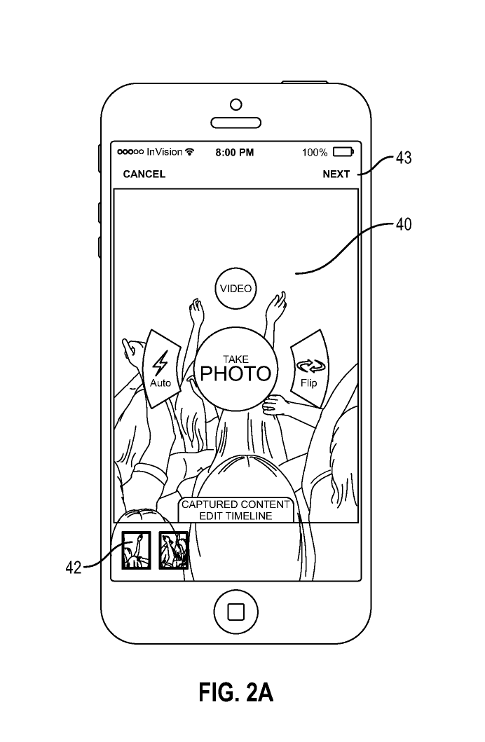

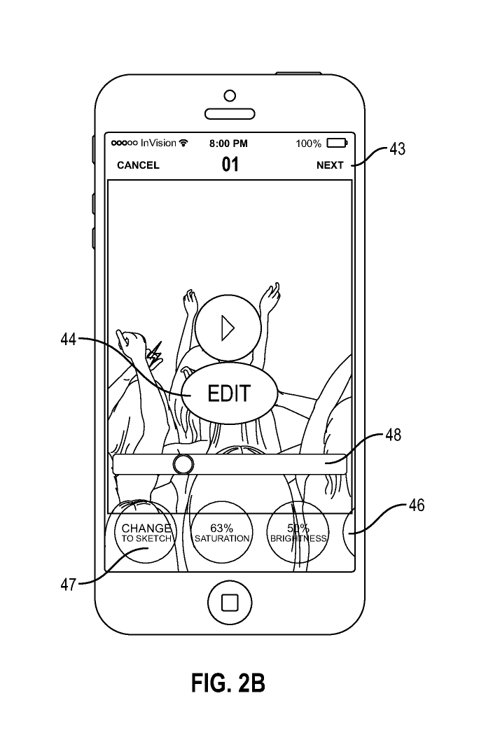

With reference now to FIGS. 2A-2B, screenshots depicting an editing feature 38 of the user interface is depicted. After each video/photo/photo-audio segment 40 has been captured, the segment appears as a thumbnail 42 at the lower portion of the screen. After the user has captured the desired compilation, he can edit each segment 40 individually by selecting that segment. FIG. 2B is the editing screen. The segment will be displayed in the center portion of the screen. An edit icon 44 will appear in the center of the media. By pressing and holding the edit icon 44, the user can adjust the brightness by dragging up/down on the screen, and adjust the saturation by dragging left/right on the screen. The user can swipe the special effects bar 46 at the bottom of the screen to select different special effects 47 to edit the media, such as contrast, shadows, warmth, etc. In addition to these editing options, a slider-bar 48 is located at the bottom of the screen for slidably adjusting the sharpness of the video/picture. This option is available even when the user's finger is not in continuous contact with the screen. When the user is finished editing each segment, he presses the “next” icon 43 in the top, right corner to finalize the media post.

With reference again to FIG. 1, the user can also record a voice-only post by pressing and holding the “audio” icon 14. By pressing/tapping the audio icon 14 once, a dialog box/keyboard will be displayed, so that the user can enter a text comment. The text comment can include a location tag, if that feature is enabled, as discussed in detail below. Alternatively, the user can press and hold the audio icon 14, which will activate the audio recording function. The microphone is activated and the user can record a voice only comment or a voice-post. The audio-only recording cannot be used as a segment in a compilation discussed above. The audio-only recording is a standalone post or comment. The recording continues until the user releases haptic contact.

For each of the compilations discussed above, the user can associate his location therewith. The user can choose to include his location before he posts media, or after he has already captured media. By pressing the location-sharing icon 28, the GPS system (52) is activated and the user's location is determined, and then associated with the captured media 29.

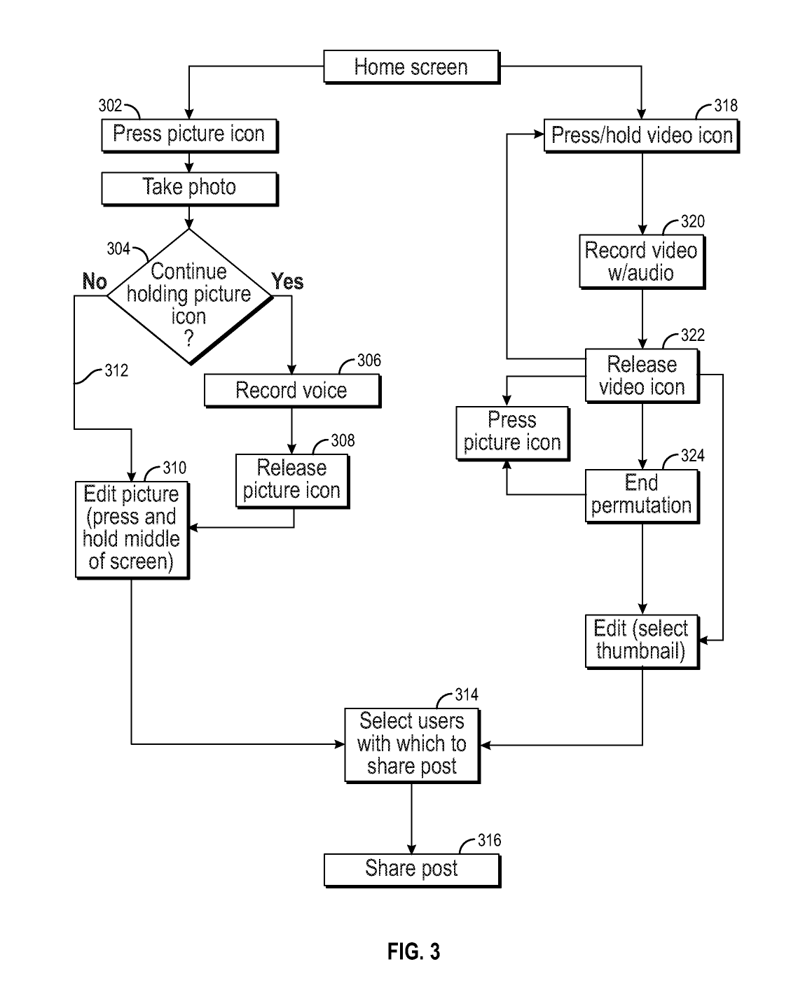

With reference now to FIG. 3, a flow chart is shown, depicting the manner in which a user can create media content. As discussed above, to take a picture, the user presses the picture icon 302. If the user continues to hold 304 the picture icon thereafter, it will record audio 306 until the user releases 308 the picture icon. If the user only taps 312 the picture icon, a snapshot is taken. After capturing the desired media, a thumbnail will appear in the bottom of the screen as shown in FIG. 2. By clicking on that thumbnail, the user enters into edit mode 310. Thereafter, the user can edit the photo by pressing and holding the still image, on the display screen, which is discussed in detail herein.

After editing, or choosing not to edit, the user then selects 314 the followers he wishes to share the post with. After selecting the users, he then shares 316 the post with the selected users. The shared post will appear on the selected users' newsfeed, viewable by only those selected users, which is discussed in detail below.

With continued reference to FIG. 3, to take a video, the user presses and holds 318 the video icon. The camera will record video and audio 320 until the user releases 322 the video icon. When the user releases the video icon, the recorded segment will be displayed as a thumbnail at the bottom of the display. The user can elect to either end the video recording 324, or to press and hold the video icon a second time to begin recording a second video segment. As discussed herein, the user could also include a photo or a photo with audio.

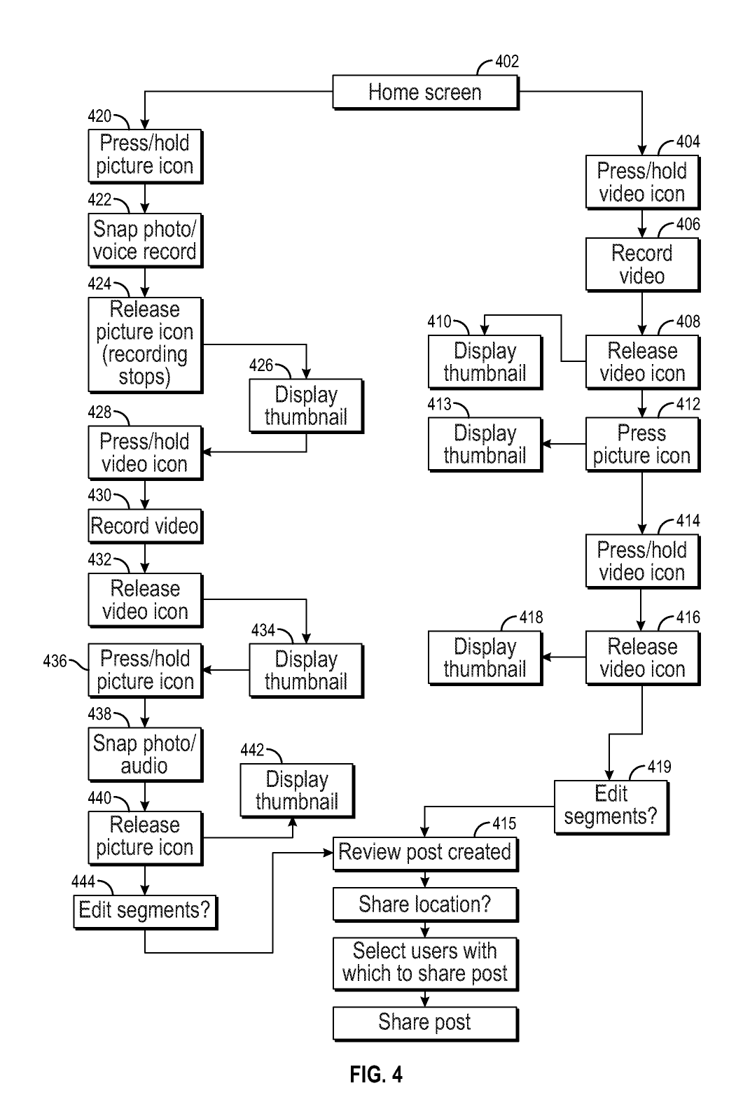

FIG. 4 is a flow chart depicting the steps for creating posts having compilations of video/picture/picture-with-audio. As explained above, after each capture, the captured video segment, picture-with-audio segment, or picture, is displayed at the bottom of the screen as a thumbnail 410 of the capture in order to make edits to each capture individually before creating and sharing the post. Starting at the home screen 402, the user can begin with a video. By pressing and holding 404 the video icon, the camera starts to record 406. The recording will continue until the user releases 408 the icon. The video will be displayed as a thumbnail 410. The user can take a picture by pressing and releasing 412 the picture icon. The picture will be displayed as a thumbnail 413. The user can take another video by pressing and holding 414 the video icon again. Upon releasing the video icon 416, the video segment will be displayed as a thumbnail 418. After editing 419, or not editing, each captured media segment, the user has created a post. In this particular example, upon review 415, the playback will display the first video, followed by a still picture, followed by the second video. The still picture between the two videos is displayed for a desired amount of time.

FIG. 4 also depicts the steps for sharing a post that begins with a picture having voice audio, then a video, then another picture with voice audio. Although the contemplated system allows for any sequence or permutation of video, photo, and/or photo with audio, this explanation is merely an example of how the system works. The user first presses and holds 420 the picture icon to take a photo and record audio 422 until he releases 424 the picture icon. Upon releasing the picture icon, the audio is paired with the photo, and a thumbnail is displayed 426. Then the user presses and holds 428 the video icon to record video footage. The footage is recorded 430 until the user releases 432 the video icon. The recorded footage is then displayed as a thumbnail 434. Then the user can press and hold 436 the picture icon to take another photo with audio recording 438. Upon releasing 440 the picture icon, audio is recorded and paired with the second photo, and displayed as a thumbnail 442. After the user has finished his second audio recording, and is finished creating/editing 444 his post, the playback will show the first photo with the first audio recording associated therewith. Then the video will play, followed by the display of the second photo with the second audio recording playback.

For example, if the user was at a concert, he could press and hold video while aiming the camera at the stage in order to record the band that is playing. After holding the video icon for 15 seconds, he releases the icon. Upon capturing this video, a thumbnail of this video segment will appear at the bottom of the screen. Then the user taps the “flip camera” icon 26 in order to take a video of himself dancing in the crowd. After flipping the camera, he presses the video icon and holds it for 10 seconds, filming himself dancing. After releasing the video icon, the user has captured this second video segment. A thumbnail of the second video segment will appear at the bottom of the screen next to the first video segment. The user can continue to capture additional videos/photos/photo-with-audio. Once the user has captured the desired compilation, the user can individually select each of the media segments displayed at the bottom of the screen in order to make edits. After selecting a segment to edit, by pressing and holding in the center of the captured media, a circular edit function appears on the screen. The user can then edit the brightness, contrast, saturation, shadows, warmth, and other special effects on each segment by continuing holding his finger in the middle of the screen and sliding it around to attain the desired result. He can also adjust the sharpness of the footage by sliding the slider-bar located at the bottom of the screen, he can do this without holding his first finger in the middle. After the user is satisfied with the edits of each video segment, the user has one post comprised of two video segments. When played back, the video of this example would show 15 seconds of the band, followed immediately by 10 seconds of footage of the user dancing.

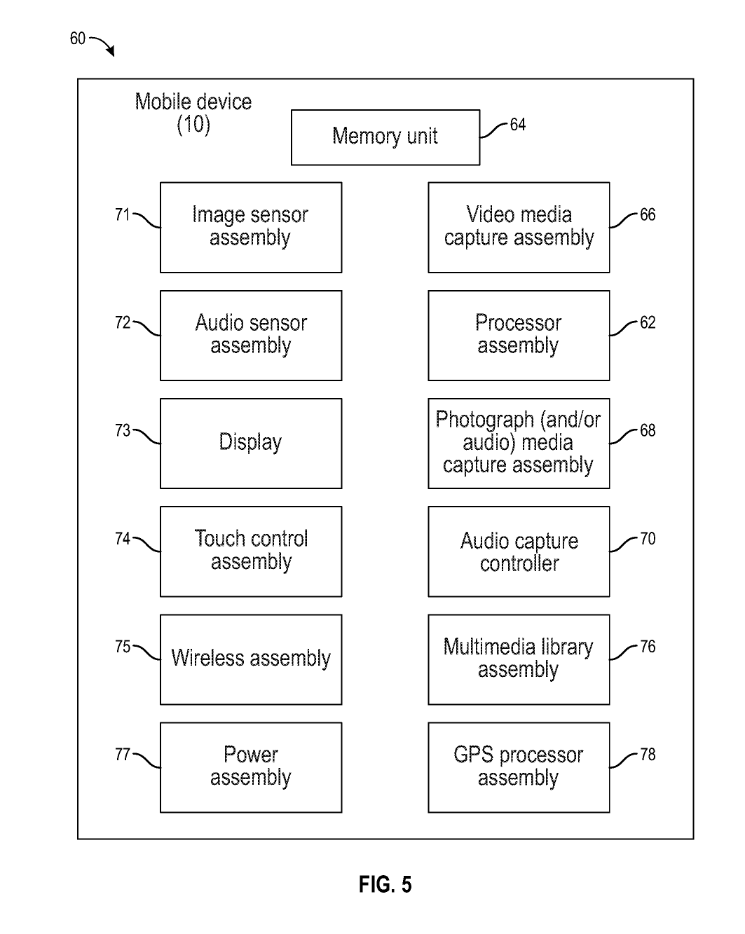

With reference to FIG. 5, an electronic device 60 implementing operations of the present invention is illustrated. In one embodiment, the electronic device is a smartphone with a processor 62 in communication with a memory unit 64. The processor may be a central processing unit and/or a graphics processing unit. The memory can be a combination of flash memory and random access memory, or other digital memory devices known in the art. The memory stores a video media capture controller 66, a photograph media capture controller 68, an audio media capture controller 70, an image sensor assembly 71, an audio sensor assembly 72, a display 73, a touch control assembly 74, a wireless assembly 75, a multimedia library assembly 76, a power assembly 77, and a GPS processor assembly 78 to implement operations of the invention. The controllers (e.g., 66, 68, 70) include executable instructions that enable the corresponding functionality, as discussed above, which are performed by processor(s) of the mobile device.

### Social Networking Functionality:

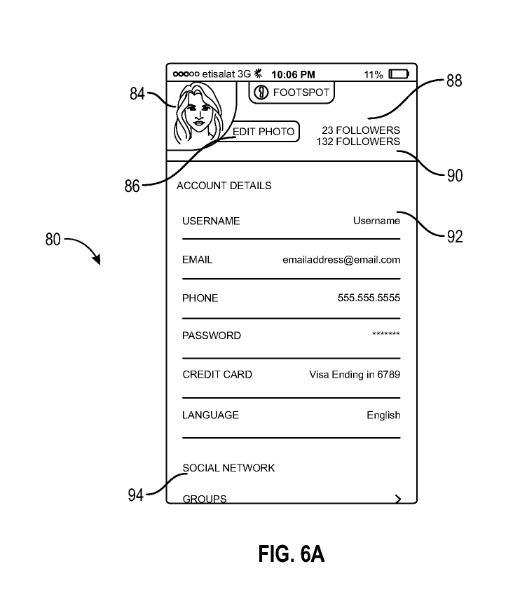

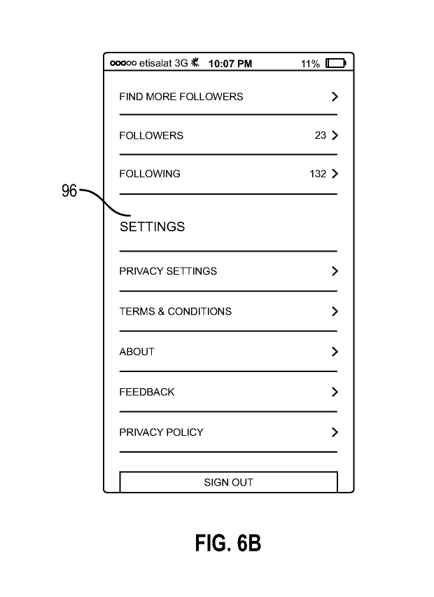

With reference now to FIGS. 6A-6B, a screenshot is shown for accessing the social networking features. The user can access the interface 80 by clicking on his “view your profile” icon 30 at the top-left of the screen of FIG. 1. This takes the user directly to his account settings, as depicted in FIGS. 6A-6B. The user's profile 84 is displayed in the upper-left corner along with an “edit profile photo” icon 86. In the upper-right corner, the number of followers (88) and the number of users he is following 90 are displayed. The main portion of the display screen lists the “account details” 92. Username, email, phone number, password, credit card on file, and preferred language. Below account details are the social network details 94. These details include groups, an option to “find more followers,” an option to view the user's current followers, and an option to view the users that he is following. Below the social network details are the settings 96 (shown in FIG. 6B). The settings include privacy settings, access to terms & conditions, about, feedback, and privacy policy.

The option to “find more followers” is where the user goes to choose his followers. Instead of having other users requesting to follow the first user, the first user, rather, requests other users to follow him. For example, first user, Xavier, sends a request to second user, Zander, asking Zander to follow Xavier. Upon approval by Zander, Zander is now following Xavier. It should be noted that this is the only way for Zander to become a follower of Xavier, e.g., Xavier must send the request to Zander, which exemplifies Xavier's desire to have Zander follow Xavier. Instead of Zander sending a request to Xavier, which exemplifies Zander's desire to follow Xavier, Xavier must initiate the ability of Zander to decide whether or not to follow Xavier by sending the request to Zander to become a follower of Xavier.

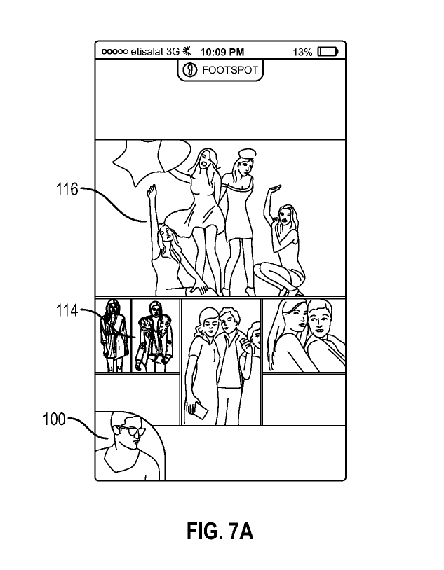

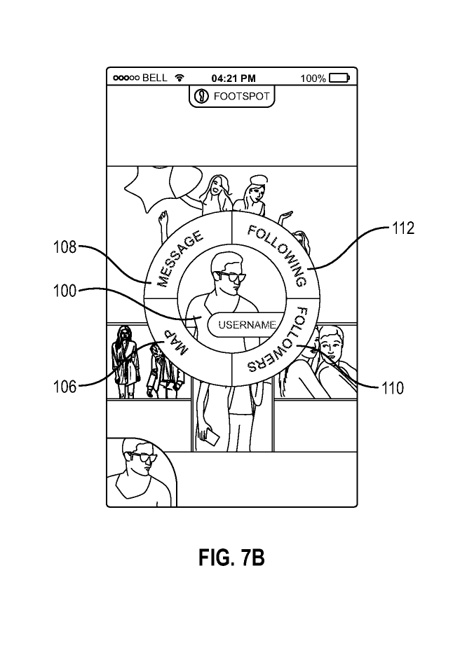

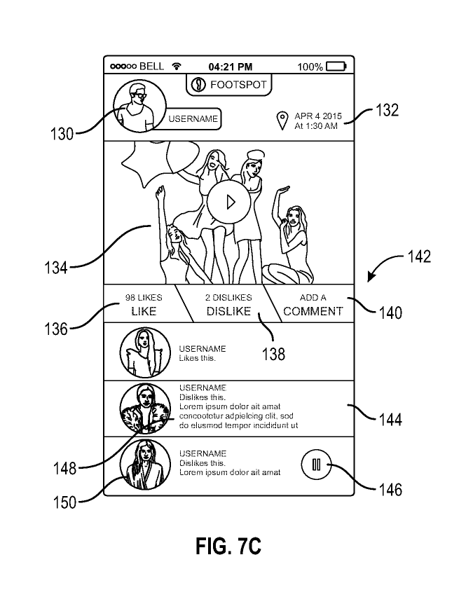

With reference now to FIG. 7A, a user interface is shown for viewing another user's profile. It shows the user's profile picture 100 and username in the bottom left corner. The user's most recent post 116 is displayed as a large thumbnail (or the actual size of the captured photo/video), while the other recent posts 114 are displayed as thumbnails along the bottom of the screen. Clicking on a post will take the user to the screen for the selected post (shown in FIG. 7C). When you click on the user's profile picture 100, it maximizes into a circle with options around the profile picture as shown in FIG. 7B. The circle of navigational icons is located around the user's profile picture and username. These icons include a send message icon (108), view followers icon 110, view following icon 112 and a “map” icon 106.

With reference now to FIG. 7C, a screenshot of a GUI is shown for when viewing a post on the user's newsfeed of the social networking. The upper left corner shows the posting-user's profile picture 130 and name. The upper right corner displays the location 132, date, and time that the post was created and shared. In the center portion, the media 134 of the post is displayed. If the media of the post is a picture with sound, or a video, a play button will be displayed in the center of the post. To play the media, the user presses and holds the play button. The post will playback while the user's finger is in contact with the center play button. To rewind or fast forward the media, the user can drag his finger from the center play button. By dragging his finger diagonally in the down/left direction, the media will rewind until the user drags his finger back to the center play button. By dragging his finger diagonally in the upper/right direction, the media will fast forward until the user drags his finger back to the center play button.

Below the displayed media portion is a bar with action icons 142. These icons include a “like” icon 136, a “dislike” icon 138, and “add a comment” icon 140. The likes, dislikes, and comments associated with the post are shown in reverse chronological order, listed below the action icon bar 142. The actions are displayed to the right of its corresponding user's profile picture. The user's name is displayed directly above the action.

When a user makes a comment 144 on a post, the comment is public in the sense that it is made available to the original poster and everyone that the post was shared with originally. Users can only comment with text or voice audio. The posted comment is displayed as a play button 146 if the comment has an audio segment. Displayed next to the play button/text is the profile picture 150 of the user who created the comment. If the comment has audio segments, that user's comment is played back by pressing the play button. If the comment was only text 148, then the text will be displayed next to the user's profile. Clicking the user's profile picture icon 150 will go to that user's profile.

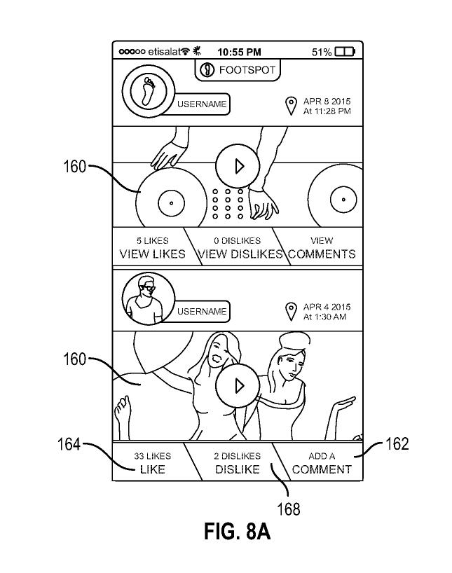

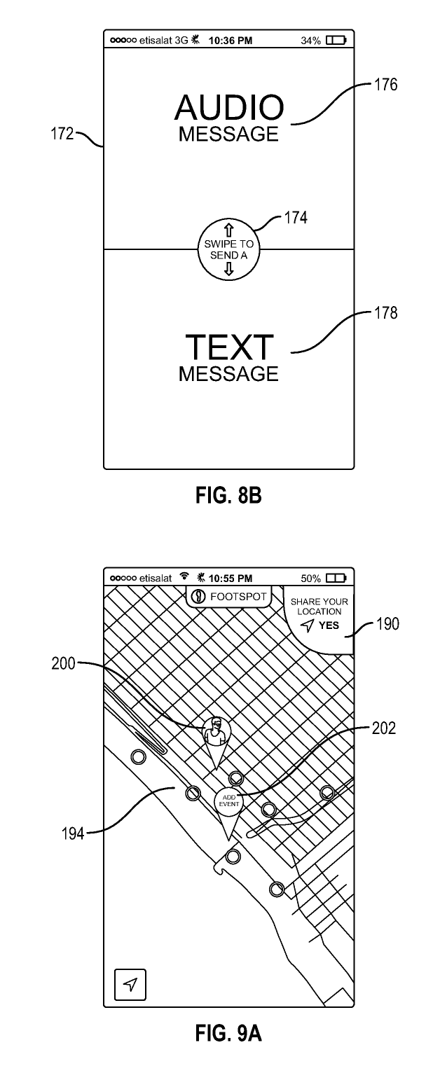

The newsfeed, displayed in FIG. 8A, is accessed by swiping from right to left on the home screen of FIG. 1. This is where the user can view posts 160 that other users have sent to him. Before a user shares a post, the user selects the group or individuals that the post will be shared with. Each post is directed to a group or individual and is not posted for the general public to view. The newsfeed displays a summary of the posts 160 shared with the particular user. Upon viewing a post, the user can submit a comment 162, like 164, or dislike 168 the post by tapping the post to submit a text comment, or by holding the post to submit a voice comment. In order to dislike a post, the user must leave an audio or a text comment paired with the dislike, otherwise the dislike will disappear. Regardless of whether the user likes or dislikes a post, he can comment on the post using the keyboard or by posting a voice recording, as shown in detail in FIG. 8B.

As shown in FIG. 8B, by pressing the “add comment” icon once, a keyboard pops up. By clicking and holding the “add comment” icon, audio recording is triggered and the user can submit a voice-comment. By pressing the “dislike” icon one time, a screen 172 pops up with a circle 174 in the middle. By swiping upwards 176 on the screen, the system starts recording a voice comment. By swiping down 178, a keyboard pops up for the user to leave an associated text comment. After swiping down and having the keyboard pop up, the user can click “cancel” in order to not leave a comment. If cancelled, the user's “dislike” will disappear from the summary of posts.

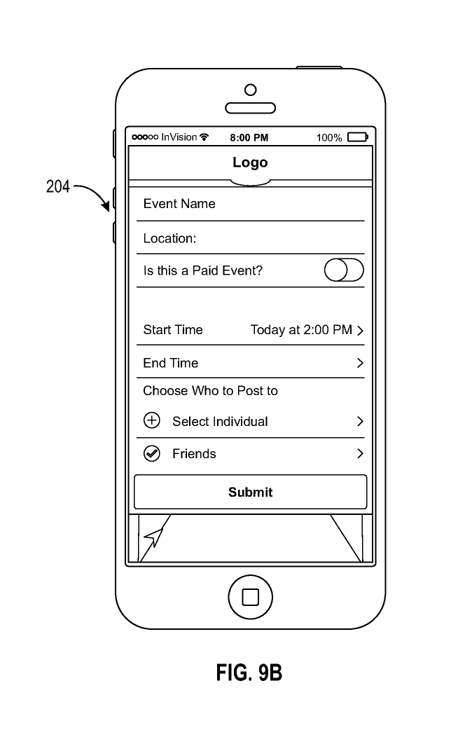

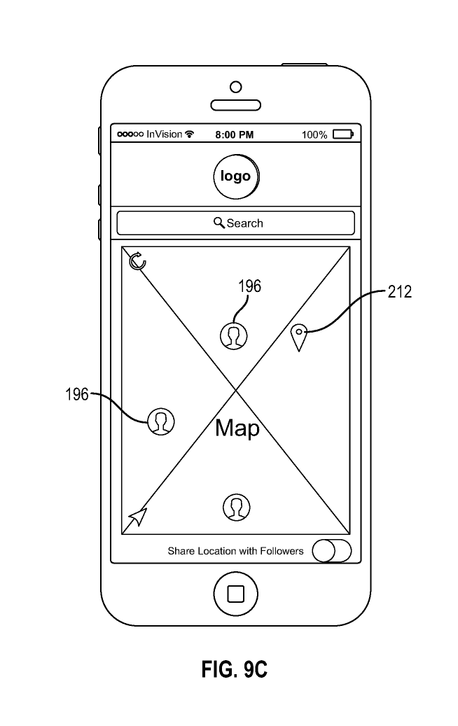

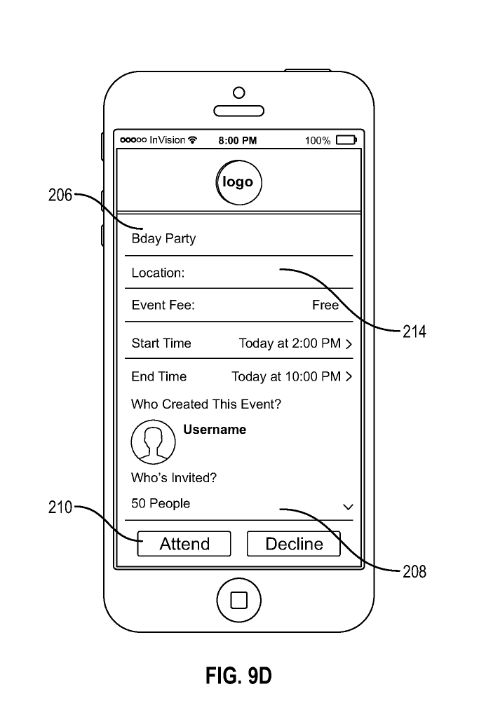

With reference now to FIGS. 9A-D, the location-sharing display 190 shows the user location pin 200 and an “add event” pin 202 as depicted on the user interface. By swiping from left to right from the home screen 20, the first user will view the map 194. The map in FIG. 9C, shows the locations of the users 196 that the first user is following. The location of each user is represented by an icon showing that user's profile picture. Clicking on a user's icon on the map will show that user's profile page. The map also displayed event pins 212.

With reference now to FIG. 9A, in order for the user to share his own location 198 without using the camera functions, he clicks on the share location icon 190 displayed in the top right of the live map shown in FIG. 9A. The Geo-location sharing icon shown in FIG. 1 is used when you want to share a location in association with the camera's functions. By clicking on any part of the map, an event creation page 204 pops up (shown in FIG. 9B). Here, the user can create an event. He can name the event, share the location (by manually entering the address or sharing his current location), disclose whether or not the event costs money, set the start time and end time, and select users to invite. Only verified users are allowed to create events that require users to purchase tickets. The invitation can be sent to a previously created group of users, or to specific individuals.

With reference now to FIG. 9C-D, upon creating an event, that event will show up on the live map page as a pin 212, indicating the location of the event. The event pin is only visible to users who received an invitation. By clicking on the event pin 212, the event screen shown in FIG. 9D for that event pops up and displays the event details 206. On this event details page, the user can view a list 208 of the people invited to the event with indications of whether they will be attending or not. The user can either accept or decline 210 the invitation on the events detail screen. The event screen will also give the user directions 214 to the event from the user's current location.

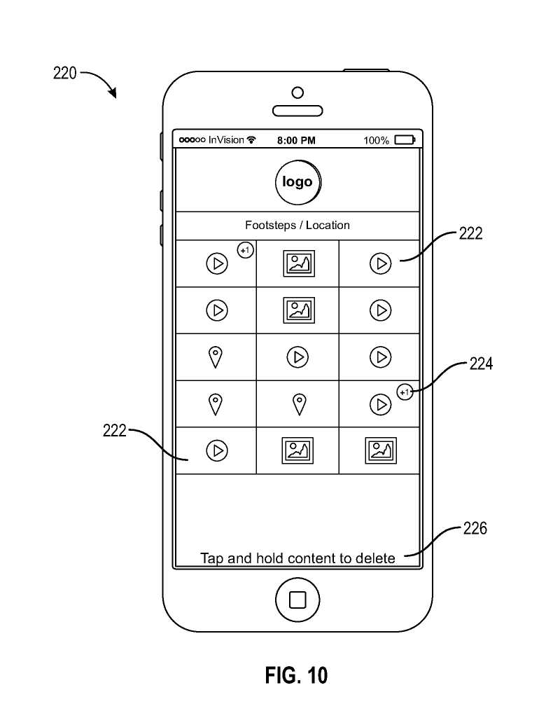

FIG. 10 displays the footsteps screen 220 as shown on the user interface. The Footsteps screen is accessed by swiping from the bottom to top on the home screen 20. The footsteps screen allows the user to view the thumbnails 222 of all of their posts. When other users make comments/likes/dislikes on a post, a badge 224 will appear on the top right corner of the post. The badge represents the number of new comments/likes/dislikes.

Posts can be deleted 226 from the footsteps screen. When deleted, posts are removed from the user's footsteps screen, and also deleted from other users that the post may have been shared with. The user can also click and hold a specific thumbnail 222 to delete that post. In an alternative embodiment, all posts could be deleted automatically after a predetermined time period, i.e., two weeks, from the date of the post.

It should be appreciated from the foregoing that the present invention provides a system and method for media capture and social networking that encourages communication via media posts in an interactive manner. The media content can be recorded via a mobile application running on a mobile device. The application presents an intuitive display in a single screen for capturing various media formats, including images, video, and audio, as well as media compilations of multiple media formats (e.g., still image and audio, video and still image, and others) in a single file. The resulting media content can be shared to the social network via the application.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. An electronic device, comprising:
a housing;
an image sensor assembly coupled to the housing that captures visual media, digitally, to include still images and video;
a display assembly coupled to the housing in digital communication with the image sensor assembly that presents visual media from the image sensor assembly, the display assembly including a display screen and a touch controller that identifies touch contact on the display screen and duration and location of the touch contact, to include initiation location and release location of the touch contact;
an audio sensor system coupled to the housing to record audio, digitally; and
a photograph touch controller that provides a photo icon on the display screen, configured to alternately capture a photograph or to capture a combination of a photograph and an associated sound recording, based upon the duration of haptic contact engagement of the photo icon and contact release; wherein a photograph is captured upon contact with the photo icon, and if contact continues with the display screen, audio is recorded for the duration of the contact, resulting in capture a photograph and associated audio for the duration of the hold until contact release.

2. The electronic device of claim 1, further comprising a video touch controller that provides a video icon spaced apart from the photo icon on the display screen, for capturing video footage for the duration of time between icon contact engagement and the icon contact release.

3. The electronic device of claim 1, further comprising an audio touch controller that provides an audio icon depicted on the display screen, for capturing an audio recording only, configured to record audio only based upon a determination of the time period between icon contact engagement and the contact release.

4. The electronic device of claim 3, wherein a tap contact of the audio icon deploys a dialog box for inputting a text message.

5. The electronic device of claim 1, further comprising an editing touch controller configured to, upon completion of each individual portion or the entire sequence, become available based upon a determination of contact with the editing icon; upon determination of constant contact with the editing touch controller icon, an interactive editing display pop-up is shown and configured to make different edits to the media based on a determination of sliding of the contact point whilst in constant contact with the touch display.

6. The electronic device of claim 1, comprising a plurality of media capture controllers providing a plurality of corresponding icons simultaneously displayed on the screen to enable capture of media in any user-desired sequence or permutation based upon which icon is activated via haptic contact, including:
a photograph touch controller that provides the photo icon on the display screen;
a video touch controller that provides a video icon on the display screen, for capturing video footage, configured to capture digital media footage for the duration of time between icon contact engagement and the icon contact release; and
an audio touch controller that provides an audio icon depicted on the display screen, for capturing an audio recording only, configured to record audio only based upon a determination of the time period between icon contact engagement and the contact release.

7. The electronic device of claim 6, wherein a tap contact of the audio icon deploys a dialog box for inputting a text message.

8. The electronic device of claim 6, further comprising an editing touch controller configured to, upon completion of each individual portion or the entire sequence, become available based upon a determination of contact with the editing icon; upon determination of constant contact with the editing touch controller icon, an interactive editing display pop-up is shown and configured to make different edits to the media based on a determination of sliding of the contact point whilst in constant contact with the touch display.

9. The electronic device of claim 6, further comprising a GPS location controller that provides a geo-tagging icon on the display screen, which enables the user to toggle on or off the sharing of the user's location.

10. The electronic device of claim 1, wherein the capture of the photograph and the associated audio is provides as a media compilation of a still image and audio that, when played, displays the captured photograph and playback of the associated audio in which the captured photograph is displayed for the duration of the playback of the associated audio.

11. An electronic device, comprising:
a housing;
an image sensor assembly coupled to the housing that captures visual media, digitally, to include still images and video;
a touch screen assembly coupled to the housing in digital communication with the image sensor assembly that presents visual media from the image sensor assembly, the touch screen assembly identifies contact location and duration, to include initiation location and release location of the contact;
an audio sensor system coupled to the housing to record audio, digitally; and
a photograph touch controller that provides a photo icon on the touch screen assembly, configured to capture a photograph or to capture a combination of a photograph and an associated sound recording, based upon the duration of haptic contact engagement of the photo icon and contact release; wherein a photograph is captured upon contact with the photo icon, and if contact continues with the display screen, audio is recorded for the duration of the contact, resulting in capture of a photograph and associated audio for the duration of the hold until contact release.

12. The electronic device of claim 11, further comprising a video touch controller that provides a video icon spaced apart from the photo icon on the display screen, for capturing video footage for the duration of time between icon contact engagement and the icon contact release.

13. The electronic device of claim 12, further comprising an audio touch controller that provides an audio icon depicted on the display screen, for capturing an audio recording only, configured to record audio only based upon a determination of the time period between icon contact engagement and the contact release.

14. The electronic device of claim 13, wherein a tap contact of the audio icon deploys a dialog box for inputting a text message.

15. The electronic device of claim 11, wherein the capture of the photograph and the associated audio is provides as a media compilation of a still image and audio that, when played, displays the captured photograph and playback of the associated audio in which the captured photograph is displayed for the duration of the playback of the associated audio.

16. The electronic device of claim 11, comprising a plurality of media capture controllers providing a plurality of corresponding icons simultaneously displayed on the screen to enable capture of media in any user-desired sequence or permutation based upon which icon is activated via haptic contact, including:
a photograph touch controller that provides the photo icon on the display screen;
a video touch controller that provides a video icon on the display screen, for capturing video footage, configured to capture digital media footage for the duration of time between icon contact engagement and the icon contact release; and
an audio touch controller that provides an audio icon depicted on the display screen, for capturing an audio recording only, configured to record audio only based upon a determination of the time period between icon contact engagement and the contact release.
